(19) United States
(12) Patent Application Publication
(10) Pub. No.: US 2002/0167391 A1
(43) Pub. Date: Nov. 14, 2002

(54) Electrical resistor and method for its manufacture

(76) Inventor: Gunther Wedeking, Dillenburg (DE)

Correspondence Address: LADAS & PARRY, 224 SOUTH MICHIGAN AVENUE, SUITE 1200, CHICAGO, IL, 60604, US

(21) Appl. No.: 10/121,408

(22) Filed: Apr. 12, 2002

(30) Foreign Application Priority Data
May 9, 2001 (DE) 101 22 468.0

(51) Int. Cl. H01C 1/02

(52) U.S. Cl. 338/252; 338/311

(57) ABSTRACT

SMD current-sense resistors are manufactured by dividing a drawn laminated wire structure that consists of a core of a resistive alloy and a jacket made of copper, e.g. After removing part of the copper jacket, jacket sections used as connector contact layers remain only at the ends of the resistor.

### BACKGROUND OF THE INVENTION

1. Field of the Invention

The invention pertains to an electrical resistor according to the preamble of claim 1, as well as a method for manufacturing resistors of this type. Specifically, the invention pertains to low-resistance components or shunts that are used in measuring current and are also suitable for surface mounting (SMD technology).

2. Background Art

Precision-measurement resistors of this type which, if so required, also must withstand high loads and typically have a resistance value in the milliohm range, for example, between 0.5 mO and 10 m (or in certain cases, even higher or lower), consist of one of the conventional and proven alloys used for this purpose, e.g., CuMnNi. The connector contact elements for the surface mounting of the resistor consist of a metal with high conductivity, particularly, copper. Until now, significant cost was required to manufacture known components of this type (see, for example, EP 0 654 799 or EP 0 841 668).

### SUMMARY OF THE INVENTION

The invention is based on the objective of allowing the manufacture of large quantities of such resistors at the lowest possible cost.

This objective is realized with the characteristics disclosed in the claims.

The connector contact elements of the resistor consequently consist of jacket sections that are formed of a welded band or tube material and encompass the usually cylindrical resistor element in tubular fashion preferably over its entire circumference. The resistor preferably consists of a drawn laminated wire structure, the jacket of which is removed between the connector contact elements such that the remaining jacket sections only consist of the connector contact elements that are separated from one another.

The described resistors not only can be manufactured very easily, e.g., of a continuously supplied laminated wire structure, but also have very high mechanical stability and can be subjected to high electric loads. In addition, the desired resistance value can very easily be adjusted over a broad range during the manufacture of the resistors, for example, by turning the resistor to a corresponding diameter.

The manufacture of the laminated wire structure utilized in accordance with the invention preferably takes place in the manner known per se for the manufacture of welding electrodes 9DE 197 12 817 C2, DE 198 10 342 A1). In this case, a bright-cleaned metal band of copper or copper alloy is continuously shaped into a tube and welded by means of conventional welding methods, e.g., TIG welding, plasma welding, induction welding or laser welding. Before the welding process, a metallically bright core that may consist of a compact wire or a laminated wire structure of several metals or alloys is inserted into the still unfinished tube. The copper jacket may be formed either by wrapping a band around the core in spiral fashion or by forming a band into a tube with a longitudinal seam. The jacket and the core are mechanically bonded into a laminated wire structure in a subsequent common shaping process, e.g. drawing or rolling. The manufactured compound wire thus formed is then conventionally drawn to the required final dimensions.

A laminated structure with relatively high mechanical stability is formed no later than during the drawing process. In order to produce an even more solid connection, a diffusion layer may be formed between the resistive alloy and the connector contact metal by annealing the laminated wire structure.

The invention is described in greater detail below with reference to the schematic embodiments that are shown in the figures on a greatly enlarged scale.

### BRIEF DESCRIPTION OF TEH DRAWINGS

The drawing figures show:

FIG. 1, a longitudinal section through a resistor according to a first embodiment example,

FIG. 2, a side view of the resistor according to FIG. 1;

FIG. 3, a practical embodiment of a plastic cap for the resistor according to FIG. 1;

FIG. 4, a second embodiment example, and

FIG. 5, a section through FIG. 4 along plane A-A.

### DETAILED DESCRIPTION OF THE PREFERRED EMBODIEMNTS

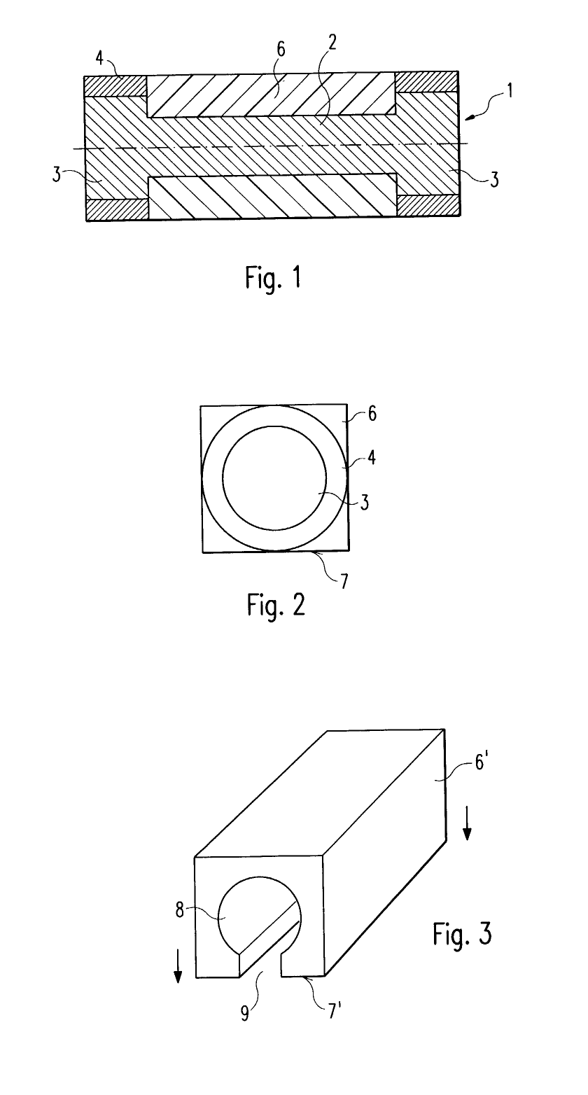

The resistor shown in FIG. 1 contains a longitudinally extended resistive element 1 that has the form of a stepped rod as shown in the figure and consists of a known resistive alloy, for example, CuNi, in particular, CuMnNi, wherein a cylindrical central section 2 is located between two cylindrical end sections 3 of larger diameter. The length and diameter of the central section are dimensioned in accordance with the desired resistance value. The two end sections 3 are each surrounded by a tubular jacket section 4 of identical axial length that consists of a material with superior electrical conductivity, e.g., copper. The jacket sections 4 are bonded onto the end sections 3 in mechanically rigid fashion and may also be alloyed to the resistive element, as described further below, in order to achieve an even better connection.

The resistive element 1 is surrounded by an insulating body 6 of heat-resistant plastic e.g., between the jacket sections 4, wherein the insulating body has at least one flat outer surface for surface-mounting the resistor, i.e., for attaching the resistor to a circuit board in the form of an SMD component. In FIG. 2, the insulating body 6 is schematically illustrated in the form of a cap with a square perimeter. The flat outer surface 7 of the insulating body 6 simplifies placement of the component on the circuit board at the intended location during the surface mounting process, since the insulating body prevents the resistor from rolling away. It is practical for the outer surface 7 to be arranged flush with the circumference of the jacket sections 4, as shown in the figure. However, other arrangements are also conceivable.

One practical embodiment of a one-piece cap 6′ that can be used as an insulating body 6 is shown in FIG. 3. This cap contains a cylindrical recess 8 that corresponds to the shape of the central section 2 in FIG. 1, wherein a longitudinal slot 9 extends into this cylindrical recess from another surface 7′. The width of this longitudinal slot is such that the cap 6′ can be pressed onto the central section 2 while it is spread apart.

Resistors of this type with resistance values in the milliohm range or below may, have a length of approximately 10 mm, e.g. wherein the central section 2 located between the copper jacket sections 4 that have a length of approximately 2 mm, e.g., may have different diameters of a few millimeters depending on the desired resistance value. However, the lengths and diameters may also be significantly larger or smaller.

In order to manufacture the resistor shown, a laminated wire structure is initially manufactured, for example, in accordance with the method described in DE 197 12 817 C2. This laminated wire structure consists of a wire core of the alloy that subsequently forms the resistive element 1 and of a welded copper jacket that subsequently forms the jacket sections 4. The laminated wire structure is drawn to the desired diameter in a drawing machine.

The drawn laminated wire structure is then annealed at a temperature that is at least as high as the recrystallization temperature of the resistive alloy (e.g., on the order of 600EC for a certain suitable CuMnNi alloy). This causes a diffusion layer to form in the boundary layer between the resistive alloy and the copper jacket. Thus, due to this diffusive annealing, both metals can be combined like an alloy.

The laminated wire structure is then again drawn to a smaller diameter in a drawing machine before it is processed further. This drawing process may, among of the things, serve for hardening the wire because a wire consisting of the metals cited above by way of example may not have sufficient hardness for being turned to size.

In order to produce the resistors, the laminated wire structure that corresponds to the cross section through the end sections 3 with the jacket sections 4 is separated into individual parts with the length of the resistor according to FIG. 1. The axially central section of the jacket between the sections 4 must be removed before, during, or after this separation such that the remaining jacket sections can be used as electrical connector contact layers of the resistor.

One practical means of removing the central section of the jacket and of dividing the wire into individual resistors consists of turning the central section of the jacket to size and then cutting off the individual resistors in a suitable automated lathe. The laminated wire structure is fed to this lathe in continuous cycles. The central section 2 of the resistive element 1 is usually turned to a diameter that corresponds to the desired resistance value and is smaller than the diameter of the laminated wire structure core and consequently that of the end sections 3 as shown in FIG. 1.

The insulating body 6 is ultimately attached in order to complete the resistor that can be used as an SMD component. For example, the plastic cap 6′ is clamped onto the central section 2 in the direction of the two arrows shown in FIG. 3, i.e., from a position in which it is parallel to the axis of the resistive element 1. This may also be realized in an automated process.

The finished resistor is annealed (age-hardened) again before or after the insulating body 6 is attached in order to electrically stabilize the resistor in a manner is considered conventional for resistance wire.

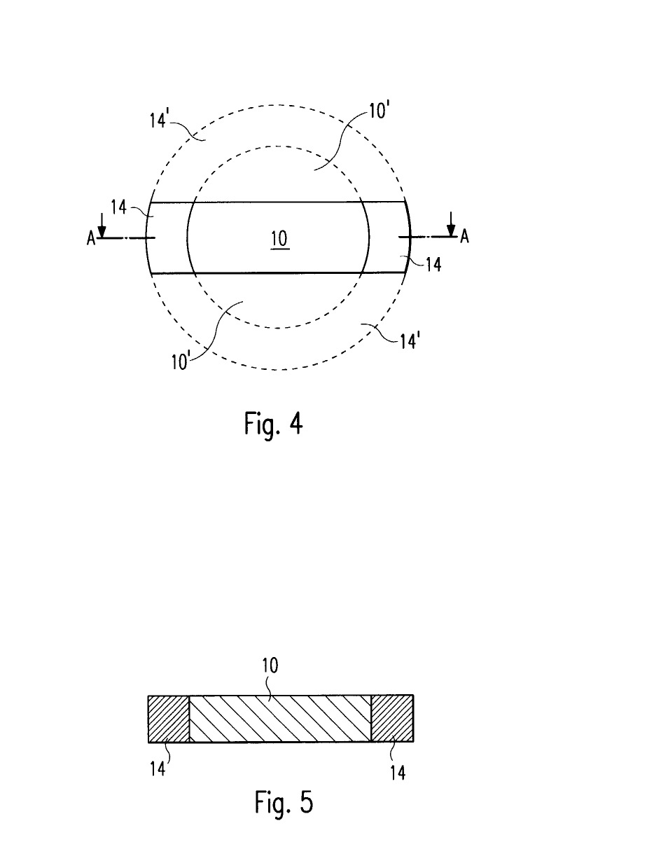

Another means of manufacturing resistors of the described type from a laminated wire structure is described below with reference to FIGS. 4 and 5. In this case, the laminated wire structure that is manufactured in the previously described manner and preferably annealed is not divided into the longitudinal sections shown in FIG. 1, but rather into individual flat disks. These disks consist of the central resistive element 10 and the two jacket sections 14 according to FIG. 4, e.g., of copper. In order to produce the resistor, the sections 14′ of the annular copper jacket that were originally located between the jacket sections 14, i.e., opposite one another on the disk circumference, are removed together with the adjacent partial regions 10′ of the resistor core.

For example, it is possible initially to divide the laminated wire structure into disks of circular shape as indicated by the broken lines in FIG. 4, wherein the regions 10′ and 14′ are then conventionally removed in a suitable manner (e.g., by means of punching). However, it would also be conceivable to carry out this process in the reverse sequence.

The resulting resistors with the flat shape shown in FIG. 5 are very suitable for use as SMD components, particularly, without the plastic cap used in the embodiment according to FIG. 1.

What is claimed is:

1. Electrical resistor, in particular, for measuring current, with a resistive element (1) that consists of a metal resistive alloy, and with two connector contact elements that are arranged at a distance from one another on opposite ends (3) of the resistive element and consisting of a metal with a higher electrical conductivity than the resistive alloy, characterized by the fact that jacket sections (4) which surround the circumference of the resistive element (1) in tubular fashion and are formed of welded band or tube material are provided as the connector contact elements.

2. Resistor according to claim 1, characterized by the fact that the resistor consists of a drawn laminated wire structure, the jacket of which is removed between the connector contact layers (4).

3. Resistor according to claim 1 or 2, characterized by the fact that the resistive element (1) is surrounded by an insulating body (6) between the jacket sections (4), wherein said insulating body has at least one flat outer surface 97) for placing the resistor onto a circuit board in the form of a surface-mount device.

4. Method for manufacturing electrical resistors by utilizing a wire material of a metal resistive alloy, characterized
in that a wire core consisting of the resistive alloy is surrounded by a jacket of a metal that has a higher electrical conductivity than the resistive alloy;
in that the jacket is welded such that a closed tube is formed;
in that the laminated wire structure formed of the wire core and its jacket is drawn to a smaller diameter, and
in that the drawn laminated wire structure is separated into parts that form the individual resistors;
wherein an axially central section of the jacket is removed on each individual resistor such that jacket sections (4) that are separated from one another and serve as connector contact elements remain only at the ends (3) of the resistor.

5. Method according to claim 4, characterized by the fact that the central jacket section is removed by means of turning.

6. Method according to claim 4 or 5, characterized by the fact that, during the removal of the central jacket section, part of the underlying resistive material is also removed until the desired diameter is obtained.

7. Method according to one of claims 4-6, characterized by the fact that a body (6) of insulating material which has at least one flat outer surface 97) is applied onto the section (2) of the resistive element 91) which is located between the jacket sections 94).

8. Method for manufacturing electrical resistors by utilizing a wire material of a metallic resistive alloy, characterized
in that a wire core consisting of the resistive alloy is surrounded by a jacket of a metal that has higher electrical conductivity than the resistive alloy 6;
in that the jacket is welded such that a closed tube is formed;
in that the laminated wire structure formed of the wire cord and its jacket is drawn to a smaller diameter; and
in that the drawn laminated wire structure is divided into disks that form the individual resistors;
wherein sections (14′) of the jacket that are located opposite one another on the disk circumference are removed from each individual resistor together with the respectively adjacent section (10″) of the resistive alloy such that jacket sections 914) that serve as connector contact elements remain only at the two ends of the remaining resistive element (10).

9. Method according to one of claims 4-8, characterized by the fact that the drawn laminated wire structure is annealed in order to realize a diffusion layer between the metal of the connector contact elements and the alloyed metal.

10. Utilization of the resistor according to one of the preceding claims for measuring currents.

11. Utilization of a resistor according to one of the preceding claims as an SMD component.
